(19) United States
(12) Patent Application Publication
(10) Pub. No.: US 2015/0169724 A1
(43) Pub. Date: Jun. 18, 2015

(54) EVENT STREAM PROCESSING SYSTEM, METHOD AND MACHINE-READABLE STORAGE

(71) Applicant: INSTITUTE FOR INFORMATION INDUSTRY, TAIPEI CITY (TW)

(72) Inventors: KU-YUAN LIN, NEW TAIPEI CITY (TW); PING-FENG WANG, MIAOLI COUNTY (TW); DZE-MIN JOU, TAIPEI CITY (TW)

(73) Assignee: INSTITUTE FOR INFORMATION INDUSTRY, TAIPEI CITY (TW)

(21) Appl. No.: 14/230,447

(22) Filed: Mar. 31, 2014

(30) Foreign Application Priority Data
Dec. 13, 2013 (TW) 102146146

(51) Int. Cl. G06F 17/30; G06F 17/14

(52) U.S. Cl. CPC G06F 17/30598; G06F 17/14

(57) ABSTRACT

The present disclosure provides an event stream processing system, comprises a gateway device and an external module. The gateway device comprises an event processing engine, and the external module comprises external processor. The event processing engine comprises an event grouping unit, a catch-collector, a processor and an event generator. The event processing engine processes a plurality events of the event stream corresponded to a rule. The event grouping unit groups the events corresponded to the rule. The catch-collector couples to the event group unit, configured for storing a first group event. The processor couples to the event group unit, configured for processing a second group event. The external module calculates the first group event and generates a first processing result. The event generator integrates the first processing result of the first group event and a second processing result of the second group event and generates a derived event.

### BACKGROUND OF THE INVENTION

1. Field of the Invention

The instant disclosure relates to a process for a series of information; in particular, to an event stream processing system, an event stream processing method and a machine-readable storage.

2. Description of Related Art

The Event-Driven Architecture (EDA) has gradually been focused and cared in recent years. The event refers to the changes of amount of the business organizations because of effects of the outside or the inside environments, and the changed states are shown with information. The application system of the Event-Driven comprises four types, including Simple Events, Brokered Event Processing, Business Process Management (BPM)-Enabled Applications and the Complex Event Processing (CEP).

So far, the Complex Event Processing (CEP) is the most prospective framework. Different to the other three kinds of event-driven systems, the Complex Event Processing is a collective/distributed system of event management, which comprises of three processing steps. First, it filters events which are not important, and groups the rest into more complex events. Finally, it makes a response to the events according to the predetermined rule. However, no matter to the Complex Event Processing or other event processing, the time-effectiveness is very much emphasized. The traditional information detected analysis is to store the real-time stream information in the database. After that, the processor detects/analyzes events, and further notices the user about the events needs to be processed. Yet, the traditional way needs to draw information from the database and to filter the drawn information, which consumes lots of time and may lose the timing to react for the business. Besides, in the traditional way, it needs to transmit events to the server for calculating such that lots of network bandwidth would be occupied. If there is no enough network bandwidth, the speed of event processing may decrease.

### SUMMARY OF THE INVENTION

The instant disclosure provides an event stream processing system, and the event stream processing system comprises a gateway device and an external module. The gateway device comprises an event processing engine and the external module comprises an external processor. The event processing engine comprises an event grouping unit, a catch-collector, a processor and an event generator. The event processing engine processes a plurality of events of an event stream corresponded with a rule. The event grouping unit groups the events corresponded with the rule. The catch-collector couples to the event grouping unit and is configured for storing a first group event from the events. The processor couples to the event grouping unit and is configured for processing a second group event. The event generator integrates a first processing result of the first group event and a second processing result of the second group event and generates a derived event. The external processor calculates the first group event and generates the first processing result.

The instant disclosure provides an event stream processing method used for an event stream processing system. The event stream processing system comprises a gateway device and an external module. The event stream processing method comprises steps as follows: filtering and grouping a plurality of events of an event stream corresponded with a rule via the gateway device; transmitting a first group event to an external module to calculate and calculating a second group event via the gateway device; generating and transmitting back a first processing result to the gateway device via the external module; and integrating the first processing result of the first group event and a second processing result of the second group event and generating a derived event via the gateway device.

The instant disclosure provides a machine-readable storage storing a code configured for implementing a process of event stream. The code is implemented via a gateway device and an external module in the following steps: filtering and grouping a plurality of events of an event stream corresponded to a rule; transmitting the first group event from the gateway device to an external module to calculate and calculating a second group event in the gateway device; integrating a first processing result of the first group event and a second processing result of the second group event and generating a derived event.

To sum up, based on the event stream processing system, the event stream processing method and the machine-readable storage, with the external module the gateway device that may be restricted to the performance of hardware and the ability of processing calculation can process a big amount of information and handle a process with complex calculation. In addition, via the external module, the instant disclosure can set a needed definition function depending on the user's needs, and the flexibility of event stream processing can be effectively increased via a general communication and a general interactive integration of information format between the external module and the gateway device. It is worth mentioning that, via the real-time processing for events of the event stream according to one embodiments of the instant disclosure, the gateway device merely transmits events needed to be processed to the connected external module for calculation, and thus it effectively saves the network bandwidth.

For further understanding of the instant disclosure, reference is made to the following detailed description illustrating the embodiments and examples of the instant disclosure. The description is only for illustrating the instant disclosure, not for limiting the scope of the claim.

### BRIEF DESCRIPTION OF THE DRAWINGS

Embodiments are illustrated by way of example and not by way of limitation in the figures of the accompanying drawings, in which like references indicate similar elements and in which:

FIG. 1 shows a schematic drawing of the processing flow of the event stream processing system or method according to one embodiment of the instant disclosure;

FIG. 2 shows a detailed block diagram of the gateway device in the event stream processing system according to one embodiment of the instant disclosure;

FIG. 3 shows a detailed block diagram of the external module in the event stream processing system according to one embodiment of the instant disclosure;

FIG. 4 shows a detailed block diagram of the gateway device in the event stream processing system according to another embodiment of the instant disclosure;

FIG. 5 shows a detailed block diagram of the external module in the event stream processing system according to another embodiment of the instant disclosure;

FIG. 6 shows a detailed block diagram of the external module in the event stream processing system according to another embodiment of the instant disclosure;

FIG. 7 shows a flow chart of the event stream processing method according to one embodiment of the instant disclosure; and

FIGS. 8-1-8-3 show detailed flow charts of the event stream processing method according to one embodiment of the instant disclosure.

### DETAILED DESCRIPTION OF PREFERRED EMBODIMENTS

With the Internet of Things advances, an event stream is transmitted to a server via a gateway device. To reduce the load when the server processes the event stream, the gateway device could be used in real-time calculation for part or the whole of event stream. However, the calculation by the gateway device is limited and the complex calculation can not be run. Therefore, the instant disclosure provides an event stream processing system. The system makes a real-time process for the event stream via the gateway device and the external module connected with the gateway device, so as to effectively save the network bandwidth and increase the speed of processing the event stream.

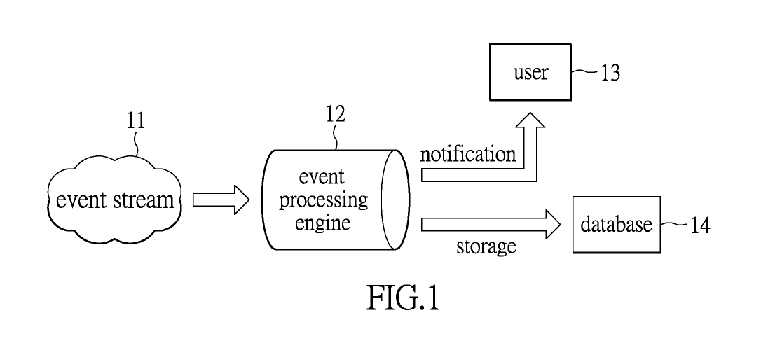

Please refer to FIG. 1. FIG. 1 shows a schematic drawing of the processing flow of the event stream processing system or method according to one embodiment of the instant disclosure. Different to the traditional detection and analysis of the data stream processing, the event stream processing system or method provided by the instant disclosure directly detects and analyzes an event stream 11 via an event processing engine 12, and notifies the user of the processed real-time event or stores the general event into a database 14. In other words, the event stream processing system or method provided by the instant disclosure can make a real-time process for events of the event stream, and there does not need to store the information of all events of the event stream in the database 14 in advance and does not further withdraw and filter the information of events of the event stream from the database 14. Therefore, it effectively increases the real-time calculation required to the event stream. The following instruction is going to further describe the event stream processing system, event stream processing method and the machine-readable storage provided by the instant disclosure.

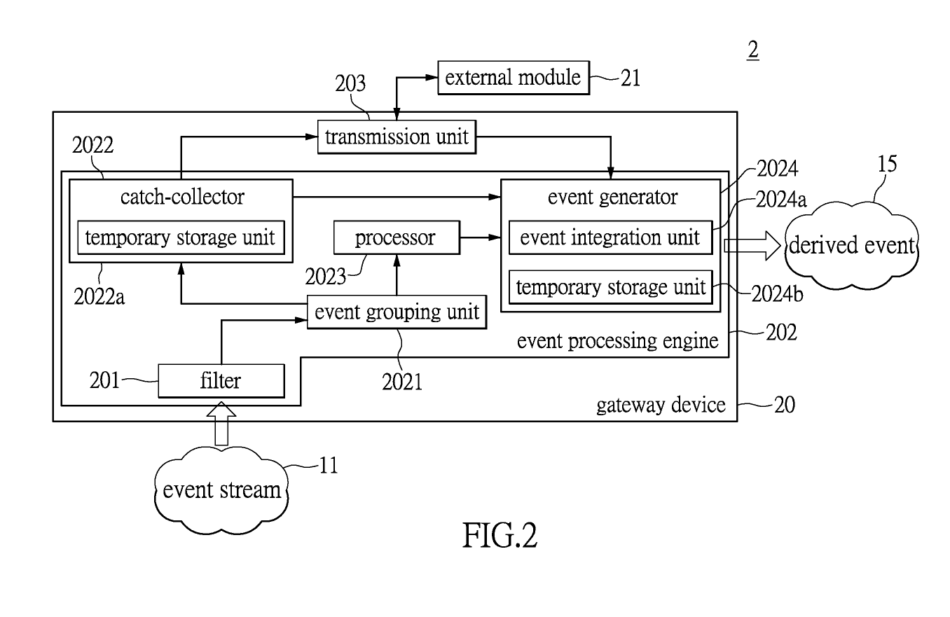

Please refer to FIG. 2. FIG. 2 shows a detailed block diagram of the gateway device in the event stream processing system according to one embodiment of the instant disclosure. The event stream processing system 2 comprises a gateway device 20 and an external module 21. The gateway device 20 comprises an event processing engine 202 and a transmission unit 203. The event processing engine 202 comprises a filter 201, an event grouping unit 2021, a catch-collector 2022, a processor 2023 and an event generator 2024. The catch-collector 2022 comprises a temporary storage unit 2022a, the event generator 2024 comprises an event integration unit 2024a and a temporary storage unit 2024b. The gateway device 20 couples to the external module 21. The event processing engine 202 couples to the transmission unit 203. The filter 201 couples to the event grouping unit 2021, the catch-collector 2022 and the processor 2023 couple to the event grouping unit 2021, and the catch-collector 2022 and the processor 2023 couples to the event generator 2024.

The gateway device 20 can be a gateway, a router, a Wi-Fi access point (Wi-Fi AP), a switch or other network relay point. The gateway device 20 is configured for connecting with the Internet or the local area network, such as the local area network used in a family or a small business. The gateway device 20 is further used for protocol conversion, impedance matching, rate conversion, fault isolation or signal conversion in a system. In the exemplary embodiment of the instant disclosure, the event processing engine 202 of the gateway device 20 receives an event stream 11 having a string of events, and further transmits a plurality of events corresponded with a rule in the event stream to an event grouping unit 2021 to process. Particularly, each event has at least one piece of datum. It is worth mentioning that the rule is defined by the user, such as logic of association, aggregation or composition and the instant disclosure is not limited thereto.

When the user filters a plurality of events of the event stream corresponded with the rule, the gateway device 20 further processes the events of the event stream corresponded with the rule via the event grouping unit 2021 of the event processing engine 202, and groups the event stream into a first group event and a second group event. The external module 21 is configured for processing the first group event, and correspondingly generating and transmitting back a first processing result to the gateway device 20. Afterwards, the gateway device 20 integrates the first processing result of the first group event and the second processing result of the second group event and generates a derived event.

The following is one of implementations of the event processing engine 202 while it is not restricted thereto. The event processing engine 202 comprises a filter 201, an event grouping unit 2021, a catch-collector 2022, a processor 2023 and an even generator 2024.

The event grouping unit 2021 groups a plurality of events in the event stream filtered by the filter 201. The event grouping unit 2021 comprises suitable circuitry, logic and/or codes used for grouping a plurality of events in the event stream into different event groups according to the complexity of calculation, data amount, time interval of the event stream. For example, the events involved in a longer history data (e.g., few weeks or few months), a data estimation or a model correction which have larger calculation load such as a matrix calculation grouped by the event grouping unit 2021 into event groups involved a large amount of data calculation, which means this kind of events are the first group events. On the contrary, the events involved in calculating general real-time average values or difference are grouped by the event grouping unit 202 into event groups involved a small amount of data calculation, which means this kind of events are the second group events. After grouping a plurality of events of the event stream by the event grouping unit 2021 according to different calculation loads, the grouped events are further transmitted to the catch-collector 2022 and the processor 2023 for the proceeding process. It is worth mentioning that, when the event grouping unit 2021 is grouping a plurality of events of the event stream, the data identification is embedded into the events by the event grouping unit 2021. The data identification is used for determining an order of calculation results to the events in the proceeding process.

The processor 2023 comprises suitable circuitry, logic and/or codes used for processing the events of the event groups having less calculation load grouped by the event grouping unit 2021, and generates and transmits processing results of the events to the event generator 2024 for the proceeding process.

The catch-collector 2022 comprises suitable circuitry, logic and/or codes. The catch-collector 2022 comprises a temporary storage unit 2022a. After the event grouping unit 2021 groups the events having larger calculation load, the corresponding events (the first group events) are transmitted to the catch-collector 2022 and then stored in the temporary storage unit 2022a. To be more detailed, the catch-collector 2022 determines whether or not the events stored in the temporary storage unit 2022a are supposed to be transmitted to the external module 21 for processing according to a predetermined reference value defined by the user and a variety of the events. The predetermined reference value can be the predetermined variety or the predetermined arrival rate of event, and the variety can be a value variety between the current event and the last event or the arrival rate of events.

For instance, the catch-collector 2022 determines whether the events stored in the temporary storage unit 2022a are supposed to be transmitted to the external module 21 for processing according to the following equation: |EVENTᵢ₊₁−EVENTᵢ|>k×STD, wherein k is a real number (e.g., k is 0.1), EVENTᵢ₊₁ and EVENTᵢ are respectively the number of pieces of data of the (i+1)-th event and the i-th event and STD is the number of pieces of one of the event groups. In other words, |EVENTᵢ₊₁−EVENTᵢ| is the amount of change can be the value variety between the current event and the last event and k×STD is the predetermined variety.

For another example, the external module 21 can predetermine the arrival rate of events and the catch-collector 2022 determines whether the events stored in the temporary storage unit 2022a are supposed to be transmitted to the external module 21 for processing according to whether the arrival rate of event of the events is equal to or larger than the arrival rate of event. For example, if the predetermined arrival rate of events is 10 events per five minutes, and when the catch-collector 2022 receives 10 events within 5 minutes, the catch-collector 2022 transmits the events stored in the temporary storage unit 2022a to the external module 21 for processing.

It is worth mentioning that, the temporary storage unit 2022a extracts the feature of data of the stored events and generates a characteristic vector and a survival data via the transformations such as Wavelet Transformation, Fourier Transformation or Discrete Cosine Transformation that are often used in the field of value analysis, but it is not limited in the obtaining and generating the characteristic vector of information to the events. It can effectively reduce the amount of data transmission to transform the data of the events via the catch-collector 2022 and transmit the characteristic vector and the survival data, and thus when transmitting data to the external module 21 the amount of data transmission can be reduced. In one embodiment of the instant disclosure, the catch-collector 2022 can determine whether to have change of value and also can transmit the event data to the external module 21 directly and further have a feature extraction, and it is not restricted thereto. Moreover, the catch-collector 2022 can further have the time stamps embedded into the events stored in the temporary storage unit 2022a, so as to examine the timeliness of the events in the next process. For example, when the catch-collector 2022 is going to transmit the data of one event to the external 32, the catch-collector 2022 would further examine whether the time stamp of the event failed. If failed, the catch-collector 2022 deletes the data of the corresponding event in the temporary storage unit 2022a and transmits a failure event to an event generator 2024.

The event generator 2024 comprises suitable circuitry, logic and/or codes. The event generator 2024 comprises an event integration unit 2024a and a temporary storage unit 2024b, used to integrate the processing results of the group events and generating a derived event 15. To be more detailed, after the processor 2023 generates and transmits the processing results to the event generator 2024, the event generator 2024 stores the results into the temporary storage unit 2024b, so as to waiting for the processing results of other group events or the failure event. Likewise, the failure event is generated and transmitted to the event generator 2024 when the catch-collector 2022 examines and determines that the time stamp of the data of the events is also stored in the temporary storage unit 2024b. After that, the event generator 2024 integrates the processing results or the failure event of the events in each event stream according to the data identification and generates the derived event 15 to be stored in the database or for informing the user.

The transmission unit 203 can be implemented by wired or wireless. A wired transmission can be implemented by Ethernet cable, USB communication interface or other interfaces of wired communication, while a wireless communication can be implemented by a Bluetooth wireless communication module or the third generation (3G) mobile communication module, and it is not restricted thereto but merely for an instruction of the instant disclosure.

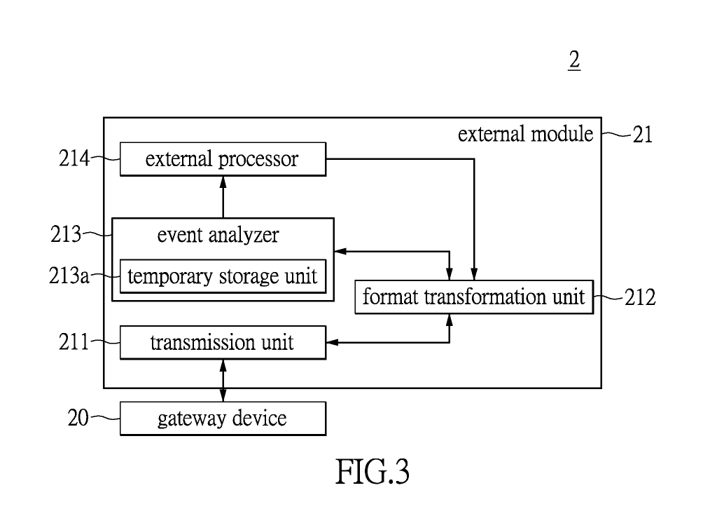

Afterwards, refer to FIG. 3 in conjunction with FIG. 2, FIG. 3 shows a detailed block diagram of the external module in the event stream processing system according to one embodiment of the instant disclosure. The event stream processing system 2 in FIG. 3 comprises a gateway device 20 and an external module 21. The external module 21 comprises a transmission unit 21, a format transformation unit 212, an event analyzer 213 and an external processor 214. The event analyzer 213 further comprises a temporary storage unit 213a. The external module 21 couples to the gateway device 20. The format transformation unit 212 couples to the transmission unit 211, the event analyzer 213 couples to the format transformation unit 212, and the external processor 214 couples to the event analyzer 213 and the format transformation unit 212.

The external module 21 can be a server, a personal computer or any device capable of calculation. In terms of the gateway device 20 is a network relay point having poor calculating ability, the external module 21 is configured for providing an additional processing ability for the gateway device 20, which does further calculation for the received group events which are more complex.

In exemplary embodiment of the instant disclosure, the transmission unit 211 of the external module 21 is corresponding to the transmission unit 203 of the gateway device 20. That is, the gateway device 20 can have a wired transmission via the external module 21 or have a wireless transmission via the external module 21. For instance, when the transmission unit 203 of the gateway device 20 is an USB communication interface, it can use the transmission unit 211 having USB communication interface, such that external module 21 and the gateway device 20 connect with each other. Or, when the transmission unit 203 of the gateway device 20 is implemented with a wireless module, it can also transmission unit which is also a wireless communication module, such as the external module 21 and the gateway device and have a wireless communication and connect with each other.

The format transformation unit 212 comprises suitable circuitry, logic and/or codes. When the external module 21 receives the group events transmitted from the catch-collector 2022 via the transmission unit 211, the format transformation unit 212 transforms the format of the group events and generates the pending events. For example, the gateway device 20 is a system using JAVA language, the external module belongs to a C language system. The format transformation unit 212 can transform group events with the JAVA language of the gateway device 20 to pending events with the C language, and transmit the events to the event analyzer 213 for next processing. Briefly, the format transformation unit 212 is used for transforming the different formats between the gateway device 20 and the external module 21.

The event analyzer 213 comprises suitable circuitry, logic and/or codes. The event analyzer 213 comprises a register 213a configured for storing the pending events after format transformation. After the format is transformed, the event analyzer 213 further examines whether or not the time stamp of the stored data transformed into the pending events fails. If yes, the failed data of the pending events is deleted, and a failure event is generated and via the format transformation unit 212 transmitted back to the event generator 2024 of the gateway device 20. If not, the data of the pending events is further transmitted to the external processor 214 for the proceeding process. It is worth mentioning that the user can set a predetermined reference value via the event analyzer 213 such that the catch-collector 2022 of the gateway 20 provides the group events needed for the calculation.

The external processor 214 comprises fail, logic and/or codes. The external processor 214 is used for processing the group events with larger calculating load and generating the result of the event processing. Afterwards, the result is transmitted bask to the event generator 2024 of the gateway device 20 via the format transformation unit 212.

Utilizes the event stream processing system provided by the instant disclosure can further expand the gateway device which is complex or cannot process a big amount of data because of being limited by original hardware framework. The instant disclosure can additionally process events with a complex calculation by the external module, and can expand different performance functions so as to support the user's requirement. Also, the instant disclosure can increase the flexibility and the instantaneity for the gateway device processing the event stream.

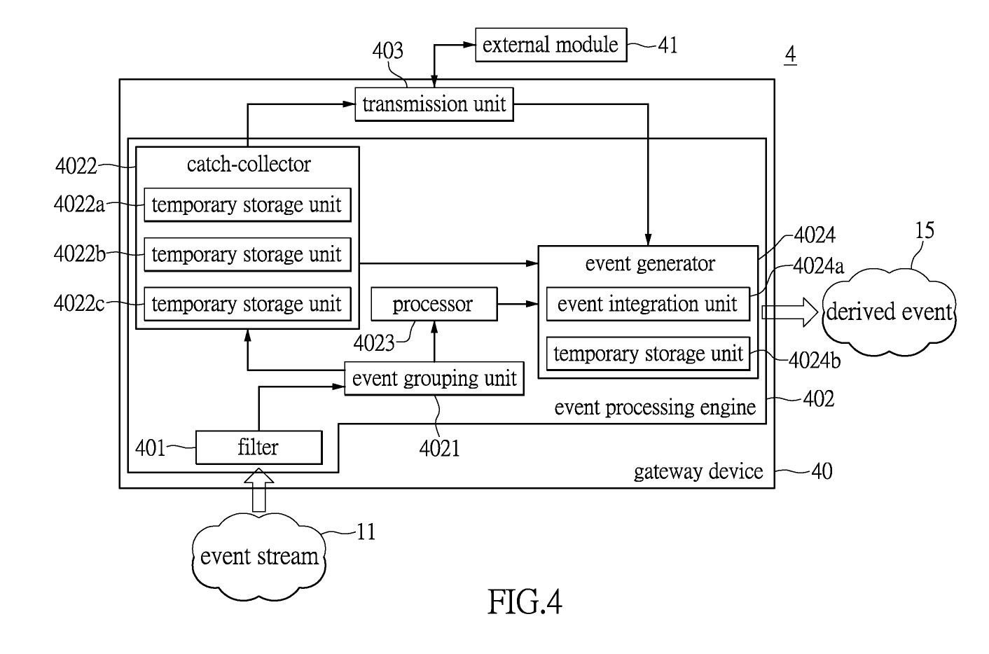

Please refer to FIG. 4, FIG. 4 shows a detailed block diagram of the gateway device in the event stream processing system according to another embodiment of the instant disclosure. The event stream processing system 4 shown in FIG. 4 comprises a gateway device 40 and an external module 41. The gateway device 40 comprises an event processing engine 402 and a transmission unit 403. The event processing engine 402 comprises a filter 401, an event grouping unit 4021, a catch-collector 4022, a processor 4023, and an event generator 4024. The catch-collector 4022 comprises a temporary storage unit 4022a, 4022b and 4022c. The event generator 4024 comprises the event integration unit 4024a and a temporary storage unit 4024b. The event stream processing system 4 shown in FIG. 4 operates in a similar manner as the event stream processing system 2 shown in FIG. 2. Different to the event stream processing system 2 shown in FIG. 2, the catch-collector of the event stream processing system 4 shown in FIG. 4 comprises a plurality of temporary storage units 4022a, 4022b and 4022c. For example, after the event grouping unit 4021 groups and transmits the event group information with larger calculating load to the catch-collector 4022, it turns into different sub-group events which are stored in different temporary storage units 4022a, 4022b and 4022c. For example, the grouped events which still have larger calculating load can be again grouped according to different targets of calculation, such as event of electric quantity information, event of moisture and temperature statistic, or the like. Moreover, corresponding to the temporary storage units 4022a, 4022b and 4022c of the catch-collector 4022, a plurality of external modules (not shown) can be further coupled to the gateway device 40 and be used for processing different sub-group events. In other words, the present embodiment can process lots of different events simultaneously. The following description merely takes a single external module for instruction, but it is not limited thereto.

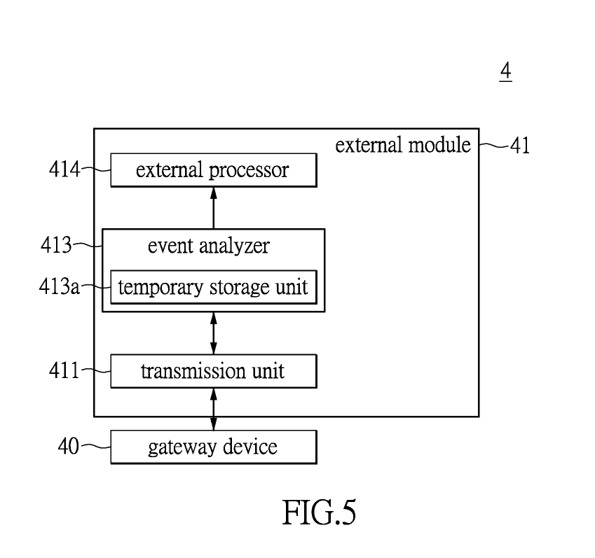

Please refer to FIG. 5, FIG. 5 shows a detailed block diagram of the external module in the event stream processing system according to another embodiment of the instant disclosure. The event stream processing system 4 shown in FIG. 5 comprises a gateway device 40 and an external module 41. The external module 41 comprises a transmission unit 411, an event analyzer 413 and an external processor 414. The event analyzer 413 further comprises a temporary storage unit 413a. The external module 41 is coupled to the gateway device 40. The event analyzer 413 is coupled to the transmission unit 411. The external processor 414 is coupled to the event analyzer 413. The difference between the external module 41 shown in FIG. 5 and the external module 21 shown in FIG. 3 is merely that, the external module 41 does not have the format transformation unit. In other words, the external module can directly use the same language and format of information as the gateway device 40 for implementation.

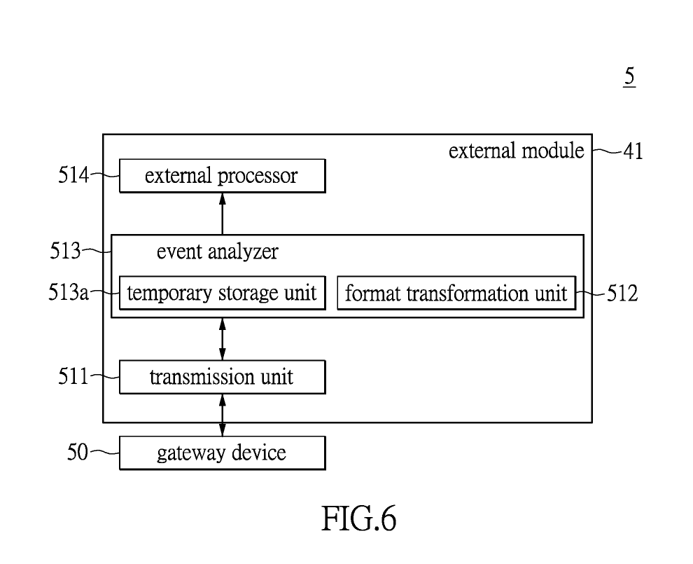

Please refer to FIG. 6, FIG. 6 shows a flow chart of the event stream processing method according to one embodiment of the instant disclosure. The event stream processing system 5 shown in FIG. 6 comprises a gateway device 50 and an external module 51. The external module 51 comprises a transmission unit 511, and event analyzer 513 and an external processor 514. The event analyzer 513 further comprises a temporary storage unit 513a and a format transformation unit 512. The external module 51 is coupled to the gateway device 50. The event analyzer 513 is coupled to the transmission unit 511. The external processor 514 is coupled to the event analyzer 513. The difference between the external module 51 shown in FIG. 6 and the external module 21 shown in FIG. 3 is that, the format transformation unit 512 can be configured in the event analyzer 513. Each element shown in FIG. 6 have the same function as each element shown in FIG. 3, so there is no need to go into details.

Having the instruction of the event stream processing system of the instant disclosure, the following description further goes to the steps of the event stream processing method operated between the gateway device and the external module.

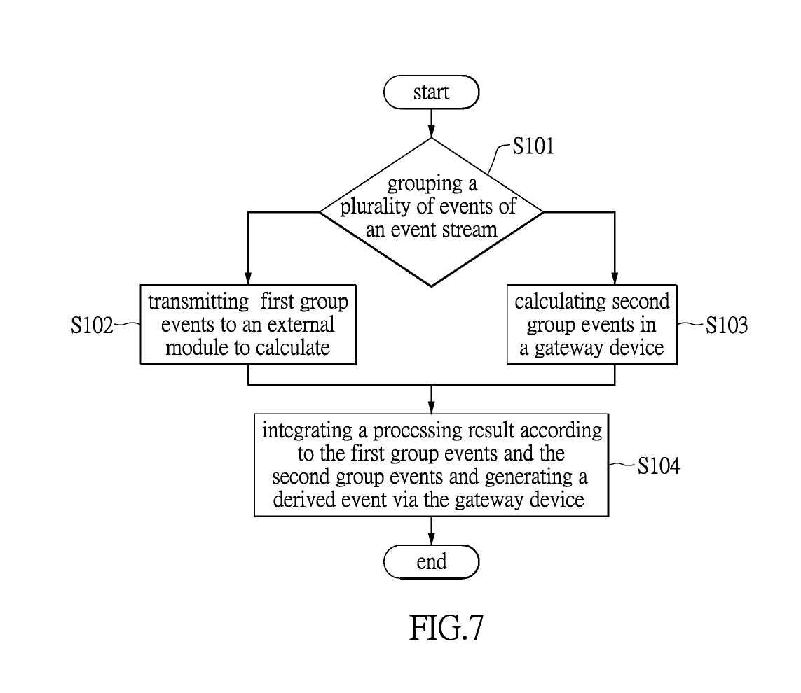

Please refer to FIG. 7, FIG. 7 shows a flow chart of the event stream processing method according to one embodiment of the instant disclosure. The event stream processing method comprises steps as flows: grouping a plurality of events of an event stream (step S101); transmitting the first group event to the external module to calculate (step S102); calculating a second group event via the gateway device (step S103); integrating the first processing result of the first group event and a second processing result of the second group event and generating a derived event (step S104).

In the event stream processing method of the present embodiment, it is mainly to first group a plurality of events of the event stream corresponded to the rule via the gateway device. After that, it is to group events which are complex or with larger calculating load as the first group events and to transmit the first group events to the external module to calculate. At the same time, it is to group events which are simple or with less calculating load as the second group events and to calculate directly in the gateway device. Finally, it is to integrate the processing result of the first group event transmitted to the external module and the processing result of the second group event processed in the gateway device and to generate a derived event, so as to notice the user or to store in into the database.

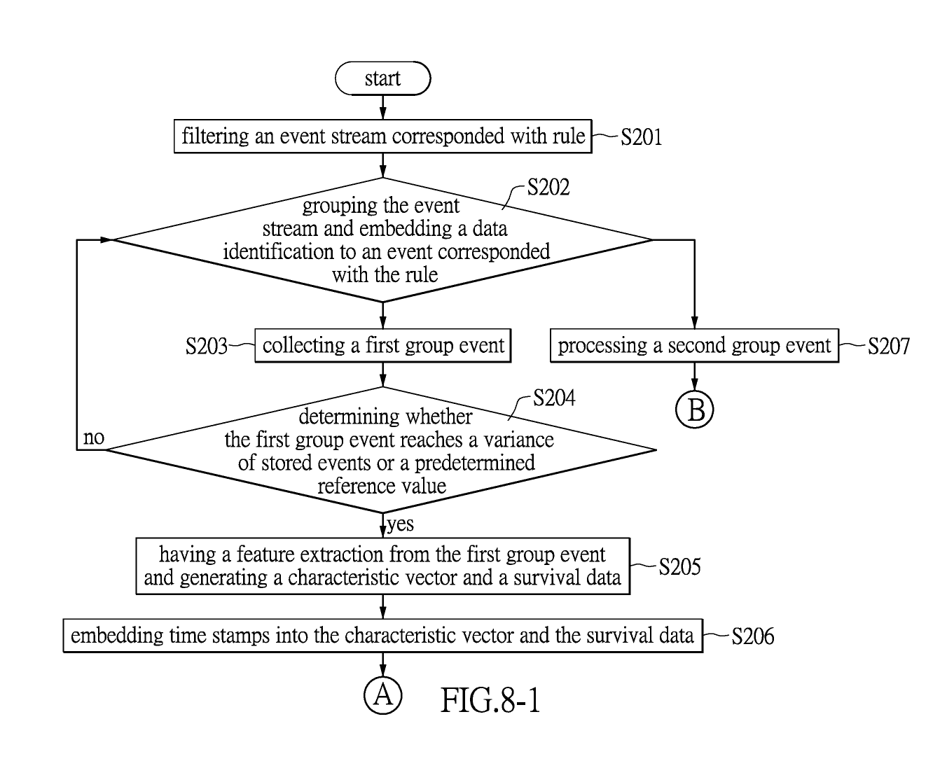

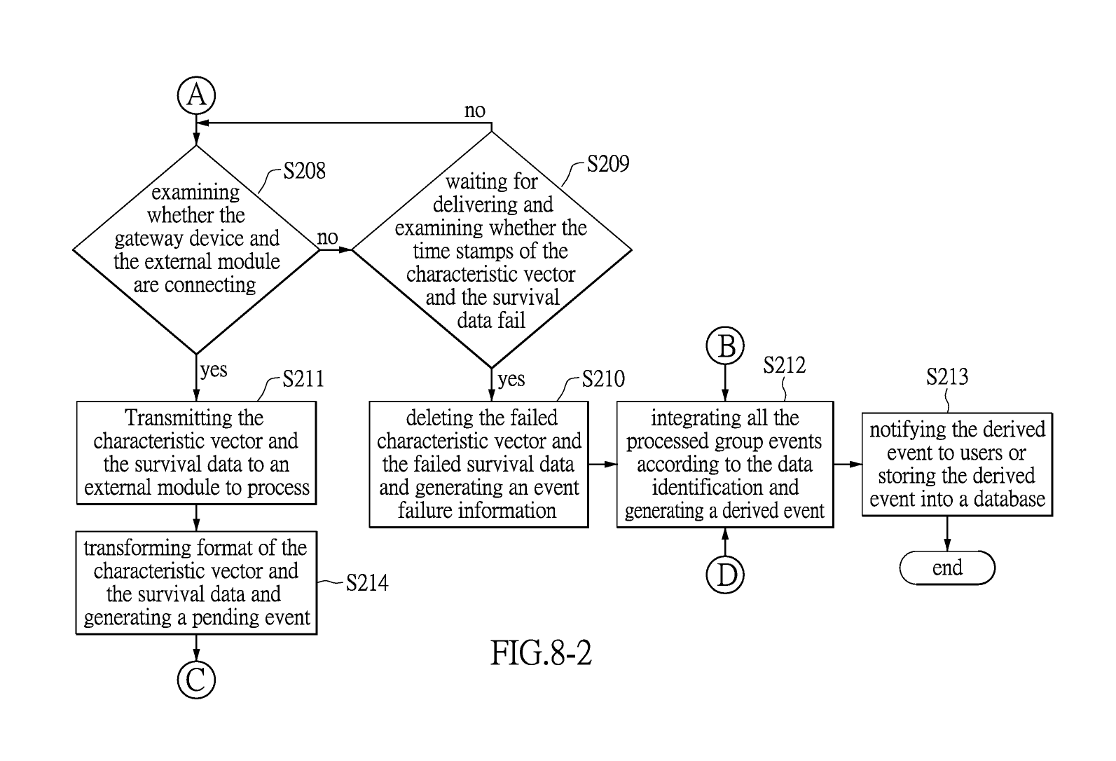

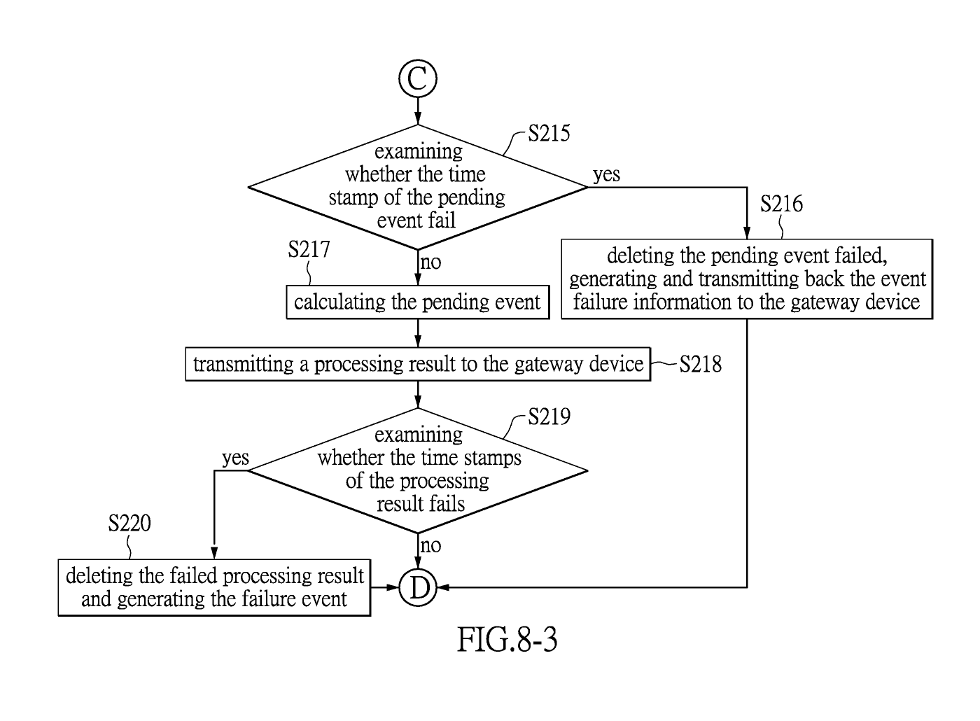

Please refer to FIGS. 8-1-8-3 in conjunction with FIG. 2, FIG. 8-1-8-3 show detailed flow charts of the event stream processing method according to one embodiment of the instant disclosure. In the step S201, the gateway device 20 receives an event steam 11 having a series of events and a plurality of events corresponded to the rule are further transmitted to the event processing engine for processing via the filter 201.

After that, in step S202, events of the event stream filtered via the filter 201 are grouped via the event grouping unit 2021. The event grouping unit 2021 groups events into different group events according to the calculation complexity, amount of information, time interval, and other grouping conditions. Also, it further has data identification embedded into each event, which is used for integrating a plurality of event results such that the order of event results can be corresponded to the order of the events.

In step S203, events with larger calculation load or needing complex calculation are grouped as the first group events and the first group events are transmitted to the catch-collector 2022. In the step S207, events with less calculation load or needing simple calculation are grouped as the second group events and the second group events are transmitted to the processor 2023. The processor 2023 generates the second processing result after calculating the second group event, and it goes to step S212. In step S212, the second processing result is transmitted to the event generator 2024.

In step S204, the catch-collector 2022 determines whether events stored by the temporary storage unit 2022a should be transmitted to the external module 21 for processing according to the reference value predetermined by the user and the changing amount of events stored in the temporary storage unit 2022a. If no, it turns back to step S202, and if yes, it goes to step S 205.

In step S 205, the catch-collector 2022 makes a feature extraction for the first group event and generates the characteristic vector and the survival data. The characteristic vector and the survival data generated by the catch-collector 2022 can effectively decrease the amount of information transmission and thus decrease the amount of information transmitted to the external module 21.

Afterwards, in step S206, the catch-collector 2022 has the time stamp embedded into the first group event so as to provide the timeliness of events for the following processing and checking. In step S208, the catch-collector 2022 examines whether the connection between the transmission unit 203 and the external module 21 is unblock. If not, it waits for the connection returning to be unblocked and goes to step S209. If yes, it goes to step S211, the characteristic vector and the survival data are transmitted to the external module 21 for processing.

In step S209, the catch-collector 2022 continuously determines whether the time stamp of the characteristic vector and the survival data fails when waiting. If not, it is to periodically examine whether the transmission unit 203 returns to be unblock. If yes, it goes to step S210 to delete the failed characteristic vector and the failed survival data and to generate the failure event to the event generator 2024 and store the failure event in the temporary storage unit 2024b for the following processing.

In step S214, the external module 21 which receives information of the characteristic vector via the transmission unit 211 further transforms the format of information of the characteristic vector having format and system language of the gateway device 20 via the format transformation unit 212, generate pending events which are provided to the external module 21 for processing, and transmits the pending events to the temporary storage unit 213a of the event analyzer 213 for storing and processing later.

After that, please also refer to FIG. 3. In step S215, the event analyzer 213 examines whether the time stamp of pending events which are store fails. If yes, it goes to step S216, the event analyzer 213 deletes the information of pending events and generates the failure event and then it goes to step S212. If not, it goes to step S217.

In step S217, the external processor 214 calculates for pending events which are received. It is worth mentioning that format of the first processing result is transformed back to format of the gateway device 20 via the format transformation unit 212, and then it goes to step S218. In step S218, it further transmits the first processing result back to the event generator 2024 of the gateway device 20 via the transmission unit 211, and then it goes to step S219. Later, in step S219, the event generator 2024 examines whether or not the time stamp of the first processing result fails. If yes, it goes to step S220, the event generator 2024 deletes the first processing result which fails and generates the event failure information, and then it goes to step S212. If not, it directly goes to step S212.

In step S212, the event generator integrates processing results which are calculated or the failure event according to the data identification, and generates a derived event. In other words, it finds the corresponding order of events according to each processing result and the failure event and makes an integration so as to generate a derived event. Afterwards, in step S213, it notices the user about the derived event or stores the derived event in the database. In the present embodiment, the first group event and the second group event are used as terms to make an instruction, but it is not limited thereto.

The instant disclosure provides a machine-readable storage, storing program codes for implementing the process of event stream. The codes can be implemented by the above mentioned gateway device and the external module in following steps. First, filtering the event stream corresponded to the rule in the gateway device and starting to group. After that, the gateway device transmits the first group event to the external module for calculating and calculates the second group event in the gateway device. Later, the external module generates and transmits back the first processing result to the gateway device. Finally, the gateway device integrates the first processing result of the first group event and the second processing result of the second group event and generates a derived event. The instant disclosure can be completed via software, hardware or the combination thereof. The instant disclosure can be completed collectively in at least one computer system, or be completed respectively in different parts in the computer that are connected with each other. The instant disclosure can be applied to any computer system or other device that can implement the above mentioned event stream processing method. Additionally, the instant disclosure can be completed according to the above mentioned method via installing and implementing the programmable computer system.

The instant disclosure can further be completed via computer-program product; the program package of product can complete all features of the instant disclosure. When the program package is installed in the computer system, via operating, the method provided by the instant disclosure can be completed. The computer program in the instant disclosure refers to any operation expression can be in any programming language, codes or symbol editing, which give the system the ability for processing information and for directly completing specific function. Moreover, in the method provided by the instant disclosure, it a) can be transformed into other language, code or symbol after one or two steps, or b) can be implemented with different format after one or two steps, so as to implement specific function.

To sum up, based on the event stream processing system, the event stream processing method thereof and the machine-readable storage of the instant disclosure, the gateway device can process a big amount of information and complex calculation via the external module. In addition, via the external module, the defining function can be set depending to the user's needs, and it can effectively increases the flexibility for processing event stream via the integration of general communication and information format between the external module and the gateway device. It is worth mentioning that, in the embodiments of the instant disclosure, it is the gateway device that processes events of the event stream in a real-time way, such that the gateway device would merely transmit events needing to be processed to the connected external module for calculating, and thus it can effectively save the network bandwidth.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. An event stream processing system, comprising:
a gateway device, comprising:
an event processing engine, processing a plurality of events of an event stream corresponded with a rule, comprising:
an event grouping unit, grouping the events corresponded with the rule;
a catch-collector, coupling to the event grouping unit, configured to store a first group event from the events;
a processor, coupling to the event grouping unit, configured to process a second group event; and
an event generator, integrating a first processing result of the first group event and a second processing result of the second group event and generating a derived event; and
at least one external module, coupling to the gateway device, each external module comprising:
an external processor, calculating the first group event and generating the first processing result.

2. The event stream processing system according to claim 1, wherein the catch-collector further comprises:
at least one of temporary storage units, configured to respectively store at least one of first subgroup events of the first group event.

3. The event stream processing system according to claim 1, wherein the event processing engine further comprises:
a filter, configured to filter and provide the events corresponded with the rule to the event grouping unit.

4. The event stream processing system according to claim 1, wherein the catch-collector is configured for a feature extraction, which generates a characteristic vector and a survival data.

5. The event stream processing system according to claim 1, wherein the catch-collector is configured for embedding a time stamp into the first group event stored.

6. The event stream processing system according to claim 5, wherein the each external module further comprises:
an event analyzer, examining the time stamp when each external module receives the first group event.

7. The event stream processing system according to claim 1, wherein the event grouping unit is configured for embedding data identification into each of the events.

8. The event stream processing system according to claim 7, wherein the event generator integrates the first processing result and the second processing result according to the data identification.

9. The event stream processing system according to claim 1, wherein each external module further comprises:
a format transformation unit, configured for transforming format of the first group event.

10. An event stream processing method, used for an event stream processing system, the event stream processing system comprising a gateway device and at least one external module, the event stream processing method comprising:
filtering and grouping a plurality of events of an event stream corresponded with a rule via the gateway device;
transmitting a first group event to at least one of external modules to calculate and calculating a second group event via the gateway device;
generating and transmitting back a first processing result to the gateway device via the external module; and
integrating the first processing result of the first group event and a second processing result of the second group event and generating a derived event via the gateway device.

11. The event stream processing method according to claim 10, wherein in the step of transmitting the first group event to at least one external module to calculate, it further comprises:
determining whether to transmit the first group event according to a predetermined reference value.

12. The event stream processing method according to claim 10, wherein before the step of transmitting the first group event to at least one external module to calculate, it further comprises:
having a feature extraction from the first group event and generating a characteristic vector and a survival data via the gateway device.

13. The event stream processing method according to claim 12, wherein the feature extraction is Wavelet Transformation, Fourier Transformation or Discrete Cosine Transformation.

14. The event stream processing method according to claim 10, wherein before the step of transmitting the first group event to at least one external module to calculate, it further comprises:
embedding a time stamp into each event in the first group event via the gateway device.

15. The event stream processing method according to claim 14, wherein in the step of transmitting the first group event to at least one external module to calculate, it further comprises:
examining the time stamp via the external module when receiving the first group event.

16. The event stream processing method according to claim 14, wherein in the step of examining the time stamp via the external module when receiving the first group event, it further comprises:
deleting the first group event and also generating an event failure information via the external module when the time stamp fails.

17. The event stream processing method according to claim 14, wherein in the step of filtering and grouping a plurality of events of an event stream corresponded to a rule via the gateway device, it further comprises:
embedding data identification into each event of the event stream via the gateway device.

18. The event stream processing method according to claim 17, wherein in the step of integrating the first processing result of the first group event and the second processing result of the second group event and generating the derived event via the gateway device, it further comprises:
integrating the first processing result and the second processing result via the gateway device according to the data identification.

19. The event stream processing method according to claim 10, wherein in the step of transmitting the first group event to at least one external module to calculate, it further comprises:
transmitting the format of the received first group event via the external module.

20. A machine-readable storage, storing a code configured for implementing a process of event stream, and the code is implemented via a gateway device and an external module in the following steps:
filtering and grouping a plurality of events of an event stream corresponded to a rule;
transmitting the first group event from the gateway device to at least one external module to calculate and calculating a second group event in the gateway device;
generating and transmitting back a first processing result to the gateway device via the external module; and
integrating a first processing result of the first group event and a second processing result of the second group event and generating a derived event.
